(19) United States
(12) Patent Application Publication
(10) Pub. No.: US 2025/0370284 A1
(43) Pub. Date: Dec. 4, 2025

(54) ELECTRICALLY CONTROLLABLE OPTICAL MODULATION DEVICE

(71) Applicant: GIST(Gwangju Institute of Science and Technology), Gwangju (KR)

(72) Inventors: Young Min SONG, Gwangju (KR); Joo Hwan KO, Gwangju (KR); Dong Hyun SEO, Gwangju (KR); Hyeon Ho JEONG, Gwangju (KR)

(73) Assignee: GIST(Gwangju Institute of Science and Technology), Gwangju (KR)

(21) Appl. No.: 19/206,426

(22) Filed: May 13, 2025

(30) Foreign Application Priority Data
May 13, 2024 (KR) 10-2024-0062775

(51) Int. Cl. G02F 1/03; G02F 1/00

(52) U.S. Cl. CPC G02F 1/0311; G02F 1/0063; G02F 2201/346; G02F 2202/022; G02F 2202/32

(57) ABSTRACT

The present disclosure relates to an electrically controllable optical modulation device and, in more detail, an optical modulation device that can be electrically controlled because it has a Tamm plasmon structure.

### CROSS REFERENCE TO RELATED APPLICATION

This application claims the benefit of Korean Patent Application No. 10-2024-0062775, filed on May 13, 2024, in the Korean Intellectual Property Office, the disclosure of which is incorporated herein in its entirety by reference.

### Technical Field

The present disclosure relates to an electrically controllable optical modulation device and, in more detail, an optical modulation device that can be electrically controlled because it has a Tamm plasmon structure.

### Description of the Related Art

Active optical modulators play an important role in construction of various components of integrated photonics, such as an optical interconnect, a photonic switch, and an optical memory.

In the related art, optical modulation has been performed using an electro-optic effect, which changes a refractive index in response to an applied electric field, but the electro-optic coefficient observed in intrinsic materials is generally small. On the other hand, by directly manipulating the plasmonic effect through carrier density modulation and transforming a material optical constant, large refractive index modulation can be achieved.

Various materials have been studied as promising candidates for active materials, but several key criteria, such as miniaturized physical size, device fabrication complexity, high modulation depth, and low operating voltage, have been pointed out as limiting factors in realizing efficient active optical modulation devices. Further, nonvolatile characteristics are preferred because they can reduce energy consumption resulting from pulsed operation. Further, electrical switching functionality is advantageous because it enables simultaneous control of multiple optical modulators at the device level.

However, achieving complete on/off optical modulation remains a challenging task in any material system, and such operation is even more difficult in the near-infrared (NIR) region. This complexity arises because the plasma frequency (ωp) of common active materials is higher than that of the NIR, so modulation is ineffective due to small absorption coefficients, and accordingly, many optical modulators have achieved high modulation depth only in the mid-infrared or longer wavelength ranges.

To solve these problems, it is important to select appropriate active materials and design optical modulation device structures.

### PRIOR ART DOCUMENT

### Non-Patent Document

I. -C. Benea-Chelmus, M. L. Meretska, D. L. Elder, M. Tamagnone, L. R. Dalton, F. Capasso, Nat. Commun. 2021, 12, 5928.
I. -C. Benea-Chelmus, S. Mason, M. L. Meretska, D. L. Elder, D. Kazakov, A. Shams-Ansari, L. R. Dalton, F. Capasso, Nat. Commun. 2022, 13, 3170.

### Disclosure of Invention

### Objective

An objective of the present disclosure is to provide an optical modulation device that maximizes an optical modulation rate, thereby providing an optical modulation device having multilevel memory and neuromorphic characteristics.

The objectives of the present disclosure are not limited to those described above and other objectives may be made apparent to those skilled in the art from claims.

### Solution

An optical modulation device according to an embodiment of the present disclosure includes: a photonic crystal structure in which different insulators are stacked; and an optical property modulation active layer formed on one surface of the photonic crystal structure.

The photonic crystal structure may be a Tamm plasmon structure.

The photonic crystal structure may include a distributed Bragg reflector (DBR) structure.

The DBR structure may include a DBR unit layer configured by stacking a first insulator layer and a second insulator layer.

The first insulator layer may be Si₃N₄.

The second insulator layer may be SIO₂.

The DBR structure may have one to four DBR unit layers.

The photonic crystal structure may include a third insulator layer disposed for one surface of the DBR structure.

The third insulator layer may be Si₃N₄.

The optical property modulation active layer may be PEDOT:PSS.

The optical modulation device may further include a porous reflective layer formed on one surface of the optical property modulation active layer.

The porous reflective layer may be gold (Au).

### Effectiveness

The optical modulation device of the present disclosure can maintain a high modulation depth over a wide spectral range from 800 nm to 2500 nm.

Further, the optical modulation device of the present disclosure can provide an array of modulator cells that are electrically programmable and optically readable memories.

Further, the optical modulation device of the present disclosure can be used as a photonic neuromorphic system that exhibits optical long-term potentiation (LTP) and long-term depression (LTD).

The effects of the present disclosure are not limited to those described above and other effects may be made apparent to those skilled in the art from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a configuration diagram of an optical modulation device according to an embodiment of the present disclosure;

FIGS. 2A and 2B show manufacturing process diagrams of an optical modulation device according to an embodiment of the present disclosure;

FIGS. 3A and 3B show diagrams a measurement device of an optical modulation device according to an embodiment of the present disclosure, in which FIG. 3A shows a configuration diagram of a reflectance and absorptance measurement device for the optical modulation device (ECTP), and FIG. 3B shows a photographic image of the actual device used (Scale bar=3 cm);

FIGS. 4A and 4B show a schematic diagram and absorption spectrum of an optical modulation device according to an embodiment of the present disclosure;

FIGS. 5A, 5B, 5C, 5D and 5E relate to a resonator using an optical modulation device (ECTP) having a high on/off modulation ratio according to an embodiment of the present disclosure, in which FIG. 5A shows a conceptual diagram of an ECTP array and a schematic cross-sectional view including structural details and electric field profiles when a cell operates as a reflector and an absorber, according to an embodiment of the present disclosure, FIG. 5B shows molecular structures of PEDOT:PSS and an optical state in which an insulating state and a metallic state can be alternately optically switched, FIG. 5C shows a simulated absorption spectrum at a target wavelength of 1500 nm at which the ECTP exhibits total reflection (ON, insulating state) and nearly perfect absorption (OFF, metallic state), FIG. 5D compares the modulation depths of various actively tunable photonic devices, and FIG. 5E shows operating voltages and operating wavelength ranges of various active materials shown in FIG. 5D;

FIG. 6 shows calculated absorption spectra at various target wavelengths;

FIGS. 7A, 7B, 7C and 7D show structural analysis of an optical modulation device (ECTP) according to an embodiment of the present disclosure using an optical switching mechanism, in which FIG. 7A schematically shows a Tamm plasmonic resonator used in optical calculations, FIG. 7B shows an equivalent conjugate-matching circuit, FIG. 7C shows optical impedance (Z/Z0) as a function of wavelength, FIG. 7D shows the complex refractive index of active materials, and FIG. 7E shows simulated electric field (left) and absorption profile (right) using metallic state PEDOT:PSS;

FIGS. 8A and 8B compare modulation depths of various active materials, in which FIG. 8A shows absorption spectra for materials used as an active layer (the top image shows absorption spectrum in a Tamm state and the bottom image shows absorption spectrum in a mirror state) and FIG. 8B shows absorption variation in each optical state of FIG. 8A;

FIGS. 9A, 9B and 9C show a modulation depth according to the number N of insulating pairs in a DBR structure, in which FIG. 9A shows electric field distribution, FIG. 9B shows an absorption profile, and FIG. 9C shows an absorption spectrum of a Tamm plasmon structure;

FIGS. 10A, 10B, 10C, 10D, 10E, 10F, 10G and 10H show proton-based electrochemical reaction characteristics with an Au membrane in an optical modulation device (ECTP) according to an embodiment of the present disclosure, in which FIG. 10A shows a schematic diagram of each unit cell of the ECTP according to an embodiment of the present disclosure, FIG. 10B shows a schematic diagram of relative ion permeability for a dense Au membrane (Dense Au) and a porous Au membrane (Porous Au)., FIG. 10C shows cyclic voltammetry (CV) curves of the ECTP with a porous Au membrane (red line) and a dense Au membrane (blue line) with respect to a reference electrode (Ag/AgCl), FIG. 10D shows a scanning electron microscope (SEM) cross-sectional image of the ECTP (left) and top-view SEM images of a dense Au electrode and a porous Au membrane (right) (Scale bar=500 nm), FIG. 10E shows a schematic diagram of relative ion and electrochemical redox reaction transport under applied voltage (top image) and corresponding variation in complex refractive index of PEDOT:PSS (bottom image), FIG. 10F is a photograph of a wafer-scale (4-inch) ECTP array, with an inset showing an individual cell (Scale bar=2 cm), FIG. 10G shows measured and simulated absorption spectra of the ECTP in oxidized state (‘Oxui’, red line) and reduced state (‘Red’, blue line), respectively, and FIG. 10H shows short-wavelength infrared (SWIR) images of individual cells in a passive matrix with on/off functions showing ‘AND’ (left), ‘OR’ (center), and ‘NOT’ (right) character images (Scale bar=3 mm).

FIGS. 11A and 11B show reflectance measurement results according to deposition methods of dense gold (Au) and porous gold (Au) according to an embodiment of the present disclosure;

FIG. 11C shows dedoping and doping reaction rates of the optical modulation device (ECTP) according to an embodiment of the present disclosure,

FIG. 12A shows a schematic diagram of an ITO-based Tamm plasmon structure and FIG. 12B shows an absorption spectrum of the ITO-based Tamm plasmon structure;

FIG. 13 shows dedoping and doping reaction rates of the ITO-based Tamm plasmon structure in FIGS. 12A and 12B;

FIG. 14 shows photographic images of the patterning size at different scales of the optical modulation device (ECTP) according to an embodiment of the present disclosure; FIGS. 15A and 15B show addressable data storage of the optical modulation device (ECTP) according to an embodiment of the present disclosure, in which FIG. 15A shows a schematic (left image) showing contact lines and the number of addressed active cells and an example showing the character ‘G’ (right image) and FIG. 15B shows a voltage value applied to each cell from the experimental result of FIG. 10H;

FIGS. 16A, 16B and 16C show verification of inter-pixel and intra-pixel uniformity of an optical modulation device (ECTP) array according to an embodiment of the present disclosure, in which FIG. 16A shows a photographic image of a fabricated ECTP including nine pixels within a 15 mm×15 mm area and the measured reflectance spectra, FIG. 16B shows a schematic of area measurement of the nine pixels, where a calibrated light source was swept across a stage to measure a reflectance spectrum of each section within a single pixel,

FIG. 16C shows reflectance contour maps measured for pixels and sub-locations, respectively, where the average wavelength (622.03 nm) and standard deviation (5 nm) among the nine pixels were calculated on the basis of a resonant wavelength (black dashed line);

FIGS. 17A, 17B, 17C, 17D, 17E, 17F, 17G, and 17H show electrically triggered optical response and programmable memory function of the optical modulation device (ECTP) according to an embodiment of the present disclosure, in which FIG. 17A shows a schematic of an electrically programmable and optically readable memory cell (top image) and circuit modeling of the memory cell based on an electrochemically active polymer (bottom image), FIG. 17B shows a reflectance-voltage (RV) hysteresis curve (Write, Read, and Erase) according to memory operation, FIG. 17C shows reflectance variation according to cyclic input voltage, FIG. 17D shows memory functions as optical logic under multiple cycles of writing, reading, and erasing, FIG. 17E shows a photographic image of the ECTP with pixelated cells (top image) and the applied voltage range for each cell for multi-bit memory function (bottom image), FIG. 17F shows RV hysteresis with four multi-memory states at different sweep ranges (left image) and SWIR reflectance images of the four states (right image), FIG. 17F also shows measured reflectance of FIG. 17F and corresponding bit levels (e.g., 00, 01, 10, 11), FIG. 17G shows encoded pixel intensities with binary/ASCII codes and decoded results, where the abbreviations Ch, Bin, Dec, and Chr indicate channel, binary, decimal, and character, respectively, and FIG. 17H shows SWIR images adjusting the intensity of the ECTP under NIR illumination before and after three months;

FIG. 18 shows that the optical modulation device (ECTP) according to an embodiment of the present disclosure is electrically programmable and optically readable, in which the left-side of FIG. 18 shows a voltage sequence applied to the ECTP and the right-side of FIG. 18 shows bit extraction and the programmed ASCII characters; and

FIGS. 19A, 19B, 19C, 19D, and 19E show the PEDOT:PSS-based neuromorphic behavior of the optical modulation device (ECTP) according to an embodiment of the present disclosure, in which FIG. 19A shows the controllability and ease of memorization of the ECTP derived from a RV hysteresis loop,

FIG. 19B shows a schematic diagram of a unit cell of the ECTP mimicking a pre-synaptic terminal and a post-synaptic terminal, FIG. 19C shows reflectance variation indicating optical potentiation, FIG. 19D shows reflectance variation indicating optical depression (in FIGS. 19C and 19D, each of electrical signal voltages Vₚₒₜₑₙₜᵢₐₜᵢₒₙ and V_{depression} is applied for 0.05 seconds of triggering and 3 seconds of relaxation), and FIG. 19E shows long-term potentiation (LTP) and long-term depression (LTD) characteristics of the ECTP under a 5 Hz electrical pre-synaptic terminal.

### DETAILED DESCRIPTION

Hereafter, embodiments of the present disclosure will be described in detail so that those skilled in the art can easily achieve the present disclosure. However, the present disclosure may be modified in various different ways and is not limited to the embodiments described herein. Like reference numerals indicate the same components throughout the specification.

An optical modulation device 100 according to an embodiment of the present disclosure may be an electrically controllable Tamm plasmon (ECTP) resonator based on a Tamm plasmon structure.

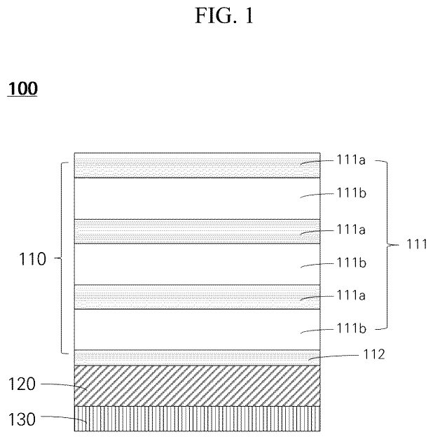

Referring to FIG. 1, an optical modulation device 100 according to an embodiment of the present disclosure includes a photonic crystal structure 110 in which different insulators are stacked, and an optical property modulation active layer 120 formed on one surface of the photonic crystal structure 110.

The photonic crystal structure 110 may be a Tamm plasmon structure and the photonic crystal structure 110 may include a distributed Bragg reflector (DBR) structure 111.

The DBR structure 111 may be formed by stacking different insulating layers, and more specifically, the DBR structure 111 may include a DBR unit layer formed by stacking two different insulating layers. The insulating layers constituting the DBR structure 111 may be a first insulating layer 111a and a second insulating layer 111b, and a DBR unit layer may be formed by stacking one first insulating layer 111a and one second insulating layer 111b. The DBR structure 111 may include 1 to 4 DBR unit layers, and more preferably, may include 3 DBR unit layers. In this case, when a plurality of DBR unit layers is included, the first insulating layer 111a is disposed on the outer surface of the DBR unit layers, and when three DBR unit layers are included, the layers are stacked in the order of the first insulating layer 111a, the second insulating layer 111b, the first insulating layer 111a, the second insulating layer 111b, the first insulating layer 111a, and the second insulating layer 111b from the outer surface. The first insulating layer 111a and the second insulating layer 111b may have different refractive indices and thicknesses from each other, the first insulating layer 111a may be Si₃N₄, and the second insulating layer 111b may be SiO₂.

The photonic crystal structure 110 may further include a third insulating layer 112 disposed on one surface of the DBR structure 111, and the third insulating layer 112 may be disposed on one surface of the second insulating layer 111b of the DBR structure, whereby both surfaces of the photonic crystal structure 110 may have the first insulating layer 111a and the third insulating layer 112 disposed thereon. The third insulating layer 112 may be Si₃N₄.

The optical property modulation active layer 120 may have optical properties that are switched by electrochemical reactions, and more specifically, may be switchable between a metallic state and an insulating state by electrochemical doping and dedoping. As an example, the optical property modulation active layer 120 may be PEDOT:PSS (3,4-ethylene-dioxythiophene: polystyrene sulfonate),

Further, the optical modulation device 100 according to an embodiment of the present disclosure further includes a porous reflective layer 130 formed on one surface of the optical property modulation active layer 120. In more detail, the porous reflective layer 130 is formed on the surface opposite to the surface where the optical property modulation active layer 120 is in contact with the photonic crystal structure 110.

The porous reflective layer 130 may be gold (Au), and more specifically, may be a porous gold (Au) membrane.

Hereafter, the present disclosure is described in more detail through embodiments.

### Embodiment 1. Manufacturing of Electrically Controllable Tamm Plasmon (ECTP) (“optical modulation device”)

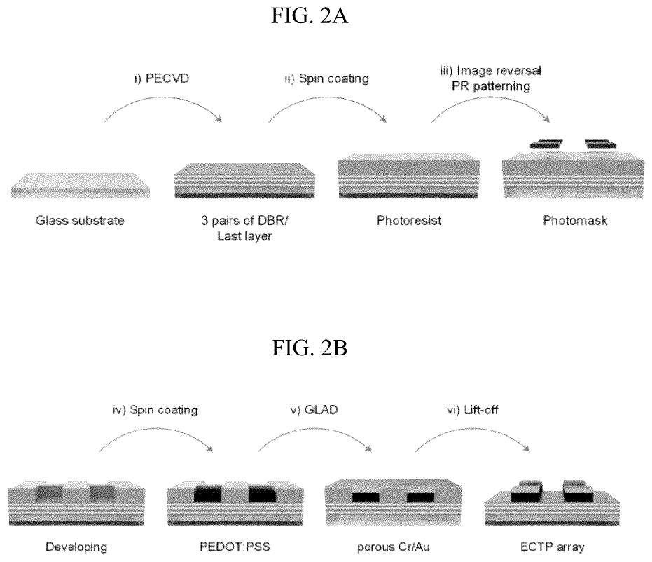

Referring to FIGS. 2A and 2B, using plasma-enhanced chemical vapor deposition (PECVD, System 100, Oxford, USA), a distributed Bragg reflector (DBR) structure composed of three pairs of insulators (SiO₂ (thickness: 259 nm)/Si₃N₄ (thickness: 188 nm)) and a last layer (Si₃N₄) (thickness: 83 nm) were formed on a glass substrate (“i) PECVD”). Thereafter, after spin coating photoresist (PR; AZ 5214, AZ Electronic Materials, Luxemburg) on the surface of the last layer (“iii) Spin coating”), an image reversal PR patterning process was performed using a Cr photomask by a mask aligner (MJB3 UV400, Karl Suss, Germany) for photolithography, whereby the area of each cell of the array was determined (“iii) Image reversal PR patterning”). Thereafter, before deposition of the PEDOT:PSS active layer, the last layer (Si₃N₄) was treated with oxygen plasma using a reactive ion etching system (RIE, PLAZMA LAB80, Oxford Instruments, UK) to form hydroxyl groups on a hydrophilic surface. An aqueous dispersion of PEDOT:PSS (PH 1000, Heraeus Clevios, was USA) filtered using a polytetrafluoroethylene (PTFE) syringe filter with a pore size of 0.45 μm. Thereafter, PEDOT:PSS was spin-coated on the surface of the last layer (Si₃N₄) at 650 rpm for 30 seconds, and then dried at 120° C. for 15 minutes, whereby residual solvent (“iv) Spin coating”) was removed. As an adhesion layer for forming a porous Au nanomembrane, a 3 nm porous Cr layer was deposited and then a porous Au nanomembrane was deposited. In this case, the deposition of Cr and Au was performed by glancing angle deposition (GLAD) using electron beam evaporation (KVE-E2000, Korea Vacuum Tech Co., Korea) with a customized tilted sample holder at a deposition angle of 70° (“v) GLAD”). Finally, cells and electrodes were formed by a lift-off process, and the ECTP was manufactured by removing the photoresist using acetone (“vi) Lift-off”).

### Analysis Example 1. Optical Simulation for Design and Analysis of ECTP

Using commercial software based on rigorous coupled-wave analysis (RCWA) (DiffractMOD, RSoft Design Group, Synopsys, USA), the electric field profile and absorption spectrum of an ECTP (Embodiment 1) were calculated.

In an optical simulation, diffraction was considered up to the second order, and a square grid size of 0.2 nm was set to obtain stable optical efficiency. Material dispersion and complex refractive indices were also considered.

The complex refractive indices of Au, SiOs, Si₃N₄, ITO, GST, VO₂, and PEDOT:PSS were obtained from the literature. To calculate the effective refractive index of the porous Au nanomembrane, the volume averaging theory was used and the calculation was performed using MATLAB (MathWorks, Inc.).

### Analysis Example 2. Electrochemical Setup and Measurement

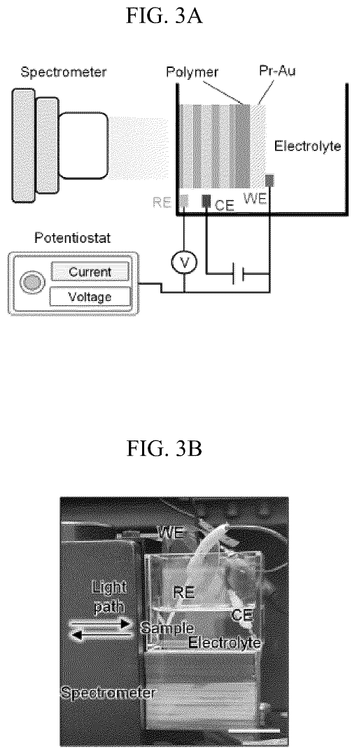

As shown in FIG. 3A, an electrochemical setup is consisted of a potentiostat (PARSTAT4000A, AMETEK, USA), a reference electrode (RE) (Ag/AgCl), a counter electrode (CE) (Pt mesh), a working electrode (WE) (Au), and an electrolyte (0.1 mol/l TBAPF6 in acetonitrile). An electrolyte was prepared by dissolving tetrabutylammonium hexafluorophosphate (TBAPF6, Sigma Aldrich) in acetonitrile (anhydrous 99.8%, Sigma Aldrich). An image of the actual device configuration used is shown in FIG. 3B.

### Analysis Example 3. Optical Characterization and Measurement

The absorption spectrum and optical hysteresis characteristics of the ECTP were analyzed using a UV-VIS-NIR spectrophotometer (LAMBDA 950, PerkinElmer, USA).

For SWIR imaging, an objective lens (NV5014SWIR, AZER, China) was mounted on an SWIR camera (ABA-003VIR, Aval, Japan). SWIR imaging of the ECTP was performed at normal incidence with the help of a 12.5 mm diameter band-pass filter (FBH051550-40, 1483-1617 nm, Thorlabs, USA) while illuminating with a tungsten (W)-halogen lamp as the light source. The optical power density measured illuminating the ECTP was 15.8 W/m², which is considered low and safe with a low possibility of damage to PEDOT:PSS through photothermal effects. Further, during the measurement process, electrochemical in-situ doping and dedoping procedures were performed using a potentiostat (PalmSens4, PalmSens, Netherlands).

### Experimental Example 1. Wavelength Selectivity Characteristics of ECTP

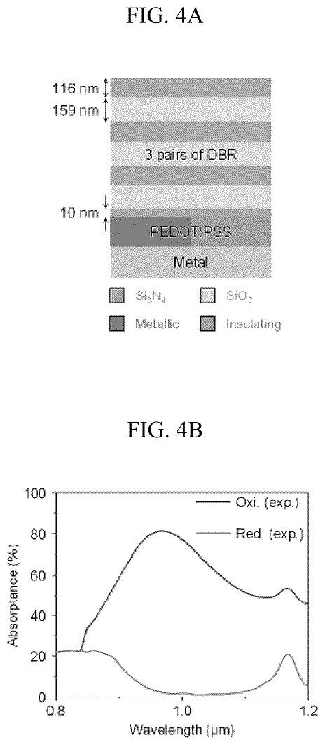

The thicknesses of the DBR and last layer constituting the ECTP array according to Embodiment 1 are shown in FIG. 4A, and the absorption spectrum is shown in FIG. 4B (Red line: oxidized state (Tamm state), Blue line: reduced state (mirror state)).

Referring to FIGS. 4A and 4B, it can be seen that the ECTP according to Embodiment 1 has an optimal optical thickness at a target wavelength of 970 nm.

### Experimental Example 2. Electrically Controllable Tamm Plasmon With High Modulation Depth

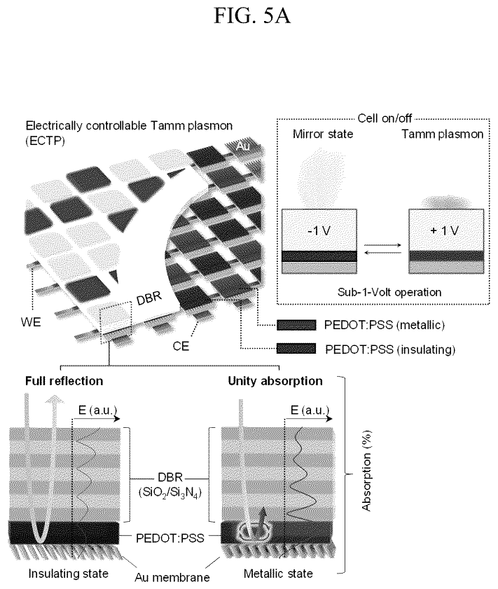

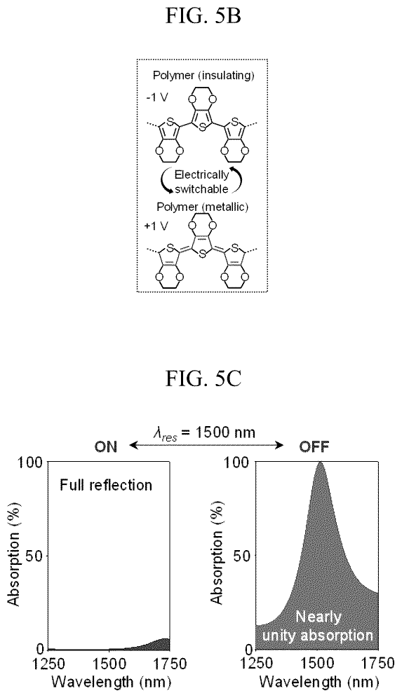

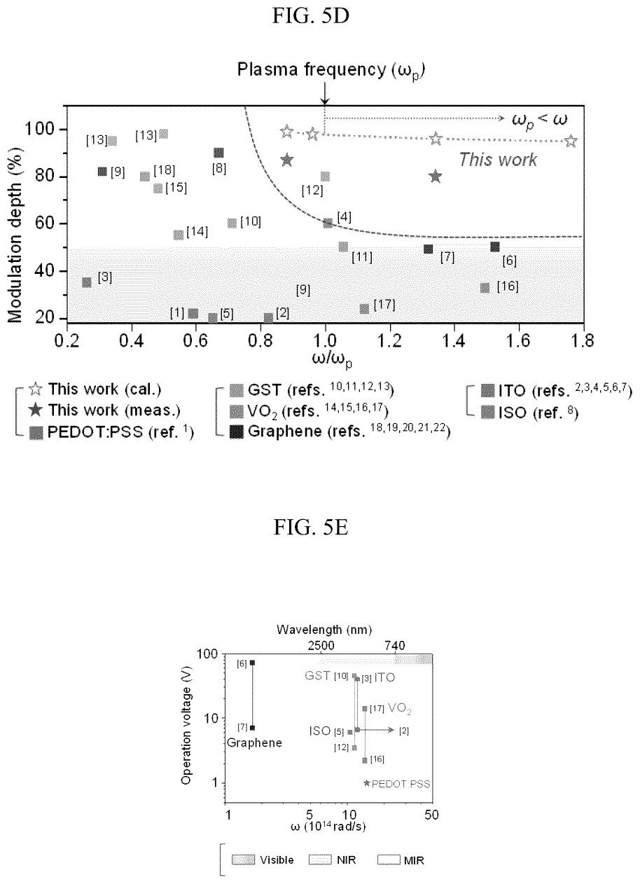

FIG. 5A shows a schematic diagram of the ECTP array according to Embodiment 1, in which each of the cells from the top to the bottom consists of DBR, PEDOT:PSS (Poly(3,4-ethylenedioxythiophene):poly(styrene sulfonate)), and an Au membrane, and is electrically controllable with a counter electrode (CE) and a working electrode (WE). Each ECTP cell can control the reflectance from nearly 0 to 1 by adjusting the applied voltage from +1 V to −1 V (see the inset of FIG. 5A). FIG. 5A also describes a detailed Tamm plasmon structure consisting of three layers of (i) DBR on (ii) PEDOT:PSS active layer and (iii) Au membrane. As shown in FIG. 5A, a strong electric field is confined at the interface between the DBR and PEDOT:PSS when PEDOT:PSS is in the metallic state, which causes strong optical absorption and narrow linewidth in the spectrum. In the insulating state, an electric field extends beyond the PEDOT:PSS layer, and incident light is reflected by the Au membrane layer. This unique response results in a high level of reflectance modulation and exceeds 99% in numerical simulations (FIG. 5C).FIG. 5B shows the chemical structures of PEDOT:PSS in an insulating state and a metallic state. The potential of PEDOT:PSS induces doping (+1V) and dedoping (−1V), thereby effectively controlling carrier density to reach about 6.5×10\hat{ }20 cm⁻³ in the metallic state.

A modulation depth is shown in FIG. 5D by comparison with values from previous research results.

The ECTP structure (Example 1) shows a higher modulation depth compared to various optical reconfigurable photonics systems that rely on variable materials such as conductive oxides (e.g., indium tin oxide (ITO) and indium silicon oxide (ISO)), graphene, and phase change materials (e.g., germanium antimony telluride (GST), VO₂). Numerous tunable devices composed of active materials integrated with nanophotonic structures have demonstrated modulation capability, but intrinsic limitations prevent achieving complete modulation efficiency. Some fundamental drawbacks include the very thin charge accumulation (or depletion) layer of conductive oxides, which implicitly indicates weakness in field-matter interaction. Although graphene-based modulators have achieved considerable modulation depth, they are unsuitable for NIR-range optical modulators because the plasma frequency (ωp) belongs to the IR-THz range.

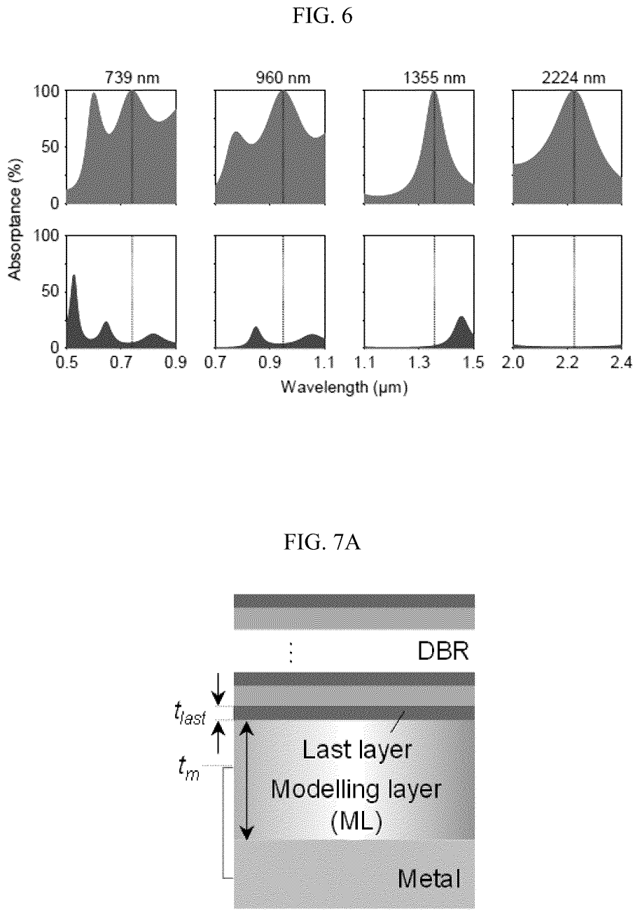

The modulation depth in the present disclosure theoretically shows 99% over the NIR range (λres=800-2500 nm), and the experimental results are shown in FIG. 6. The measured modulation depths are presented as maximum values. FIG. 6 shows absorption spectra calculated at various target wavelengths, in which the top image shows an absorption spectrum in the Tamm state and the bottom image shows an absorption spectrum in the mirror state. Referring to FIG. 6, the modulation depths at wavelengths of 739, 948, 1355, and 2224 nm are 95%, 96%, 98%, and 99%, respectively.

The enhanced modulation depth can mainly be attributed to three factors.

First, robust light confinement promoted by the Tamm plasmon allows strong light absorption despite the marginal metallic property of PEDOT:PSS (i.e., εr˜0). Second, the lossless state of PEDOT:PSS (the real part of the dielectric function, εr>1) ensures maximum light reflection. Third, compared to other active materials, the higher ωp of PEDOT:PSS (1.45×10¹⁵ rad/s, λp=1300 nm) enables device operation in the shorter NIR range.

In particular, under the condition that εr is positive and the target resonance frequency is equal to or greater than ωp, a high modulation depth exceeding 50% is achieved only in the present disclosure. Further, low operating power is essential for compatibility with standard CMOS operation (<3.3 V). In this regard, FIG. 5E shows the prominence of PEDOT:PSS at a small operating voltage (+1 V), and the x-axis displays the ωp of each material.

Among these, the ωp of PEDOT:PSS is distinguished as having the highest value, so it can be applied to the short-wavelength range around the NIR region.

### Experimental Example 3. Computational Modeling of Active Tamm Plasmon

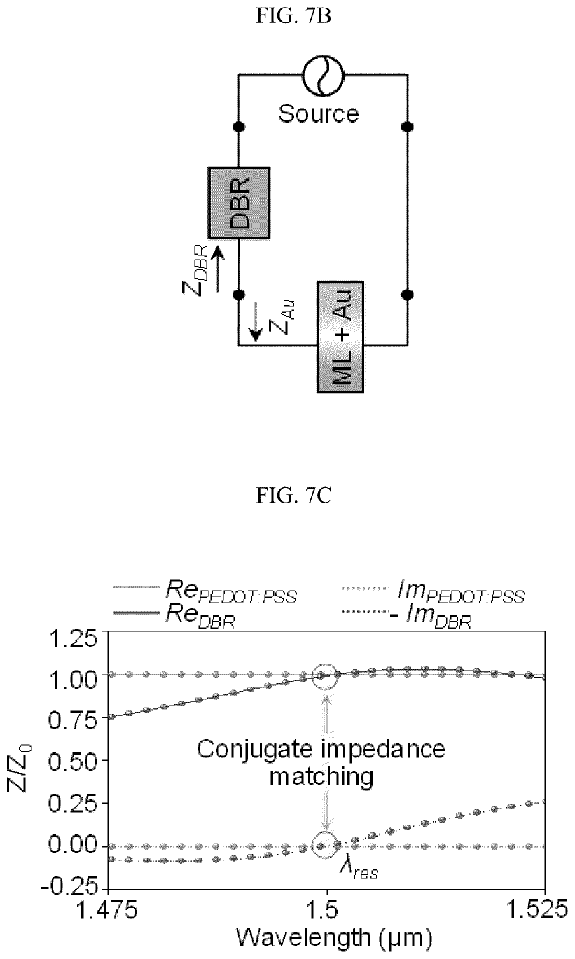

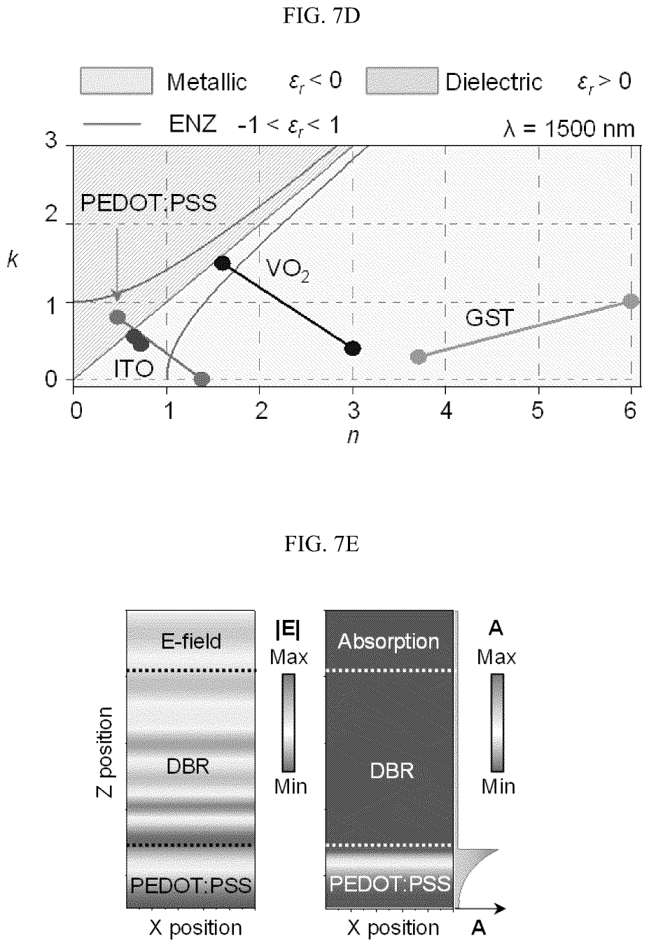

FIG. 7A shows a schematic diagram of the structure used for calculation modeling of the active Tamm plasmon in the ECTP of Embodiment 1. The DBR is stacked with three pairs of SiO₂/Si₃N₄ on the final layer (Si₃N₄).

In the case of the Tamm plasmon state, a resonance wavelength (λres) should be positioned at the center wavelength of the stop band driven by the DBR. The thickness of the DBR layers can be obtained by calculating one-quarter wavelength in a medium, for example, t=λres/4n, where n is the effective refractive index of the DBR. This equation yields thickness values of 259 nm and 188 nm for SiO₂ and Si₃N₄, respectively, at a resonance wavelength (λres) of 1500 nm. Then, the thickness of the last layer was calculated as 83 nm from Equation 1 below.

$$1 - \text{?} exp ( 2 ik \text{?} ) ∼ \text{?} \qquad [ Equation 1 ]$$

$$\text{?} \text{indicates text missing or illegible when filed}$$

In Equation 1, rPEDOT:PSS is the reflection coefficient of the wave incident on PEDOT:PSS, and rDBR is the reflection coefficient of the wave incident on the DBR from the last Si₃N₄ layer.

Next, to achieve narrowband and unity absorption, impedance was optimized using an equivalent conjugate-matching circuit. Conjugate impedance matching is a standard method in transmission line theory aimed at optimizing power transfer from a source to a load and leads to the relation ZPEDOT:PSS=Z*DBR. In this case, ZPEDOT:PSS is the impedance of the PEDOT:PSS layer, and Z*DBR is the conjugate impedance at the DBR surface.

The equivalent circuit diagram of FIG. 7A is shown in FIG. 7B as a conjugate-matching transmission line model of an ECTP structure. By considering metallic PEDOT:PSS as a modeling layer, ZPEDOT:PSS and Z*DBR were calculated.

FIG. 7C shows the real and imaginary parts of optically computed impedance. In FIG. 7C, Z₀ refers to vacuum impedance, Wo refers to vacuum permeability, and ε₀ refers to vacuum permittivity. The imaginary part of the optical impedance exhibits opposite signs between the DBR and PEDOT:PSS, while the real part has the same value at 1500 nm. This leads to an optical Tamm state at the interface between the DBR and PEDOT:PSS, thereby allowing for nearly perfect absorption. Under these conditions, the optical impedance at the surface is directly linked to the topological properties of the material, which are mediated by the geometric phase of the photonic band (i.e., Zak phase), thereby guaranteeing the existence of the Tamm state.

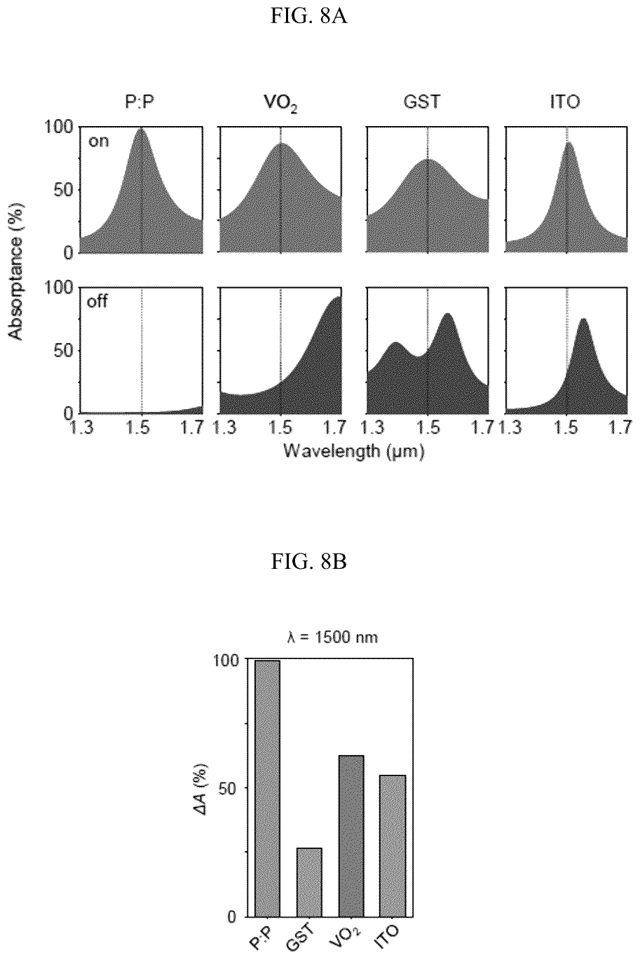

Possible refractive index variation ranges for various active materials including PEDOT:PSS, GST, ITO, and VO₂ are shown as a complex refractive index diagram in FIG. 7D. The domain is classified into three sectors of metallic (εr<0), dielectric (εr>0), and epsilon-near-zero (ENZ) in accordance with the value of εr (εr=n₂−k₂), where εr is between −1 and 1. In particular, only PEDOT:PSS exhibits various optical properties in both the metallic and dielectric regions, which leads to efficient on/off modulation of the Tamm plasmon. In contrast, ITO, VO₂, and GST exclusively change optical properties within the dielectric region, which results in a small modulation depth. FIG. 8 shows numerically simulated absorption spectra of the theoretically achievable maximum on/off ratios when the device's active layer is replaced with PEDOT:PSS, VO₂, GST, and ITO. In FIG. 8A, the thickness (t last) of each last layer was designed in correspondence to the complex refractive index of a candidate active material, and the thickness of an indium tin oxide (ITO) layer as an active layer was set to 1 nm that is a charge accumulation thickness obtained from the literature. Materials other than PEDOT:PSS (P:P) show reduced modulation depths, and ITO has an inherent disadvantage that hinders efficient absorption in the Tamm state due to a very thin (<2 nm) charge accumulation layer.

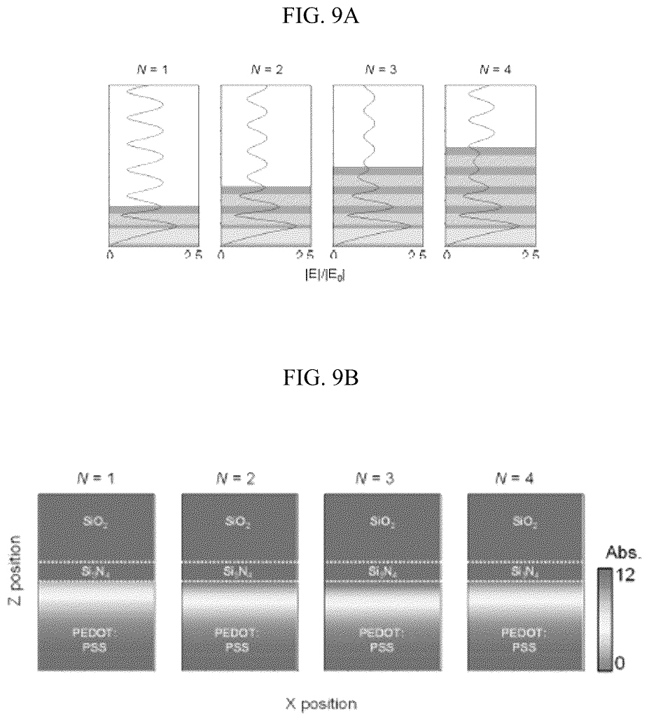

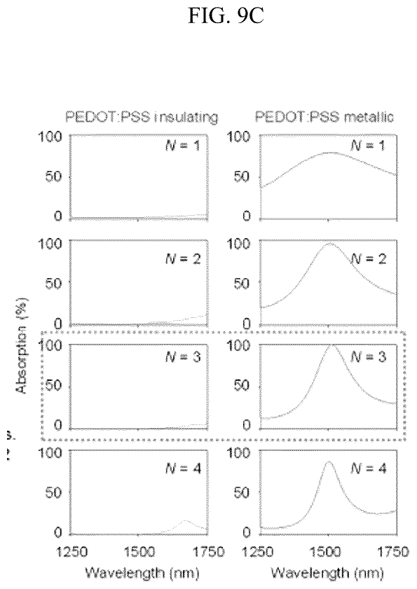

FIG. 7E shows simulated electric-field magnitude profile and absorption at a resonance wavelength. The electric-field profile exhibits a distinct standing wave pattern with highest intensity at the interface between the DBR and the PEDOT:PSS (metallic state) layer. It should be noted that the Tamm plasmon completely absorbs the confined electric field located at the interface of the metallic layer, despite the weak metallic nature of PEDOT:PSS in the NIR wavelength range. The electric field and absorption profiles in the insulating state of PEDOT:PSS are shown in FIGS. 9A, 9B and 9C.

Further, the characteristics of the Tamm plasmon mode are also influenced by adjustments to the DBR layer configuration, particularly the material combination (the refractive index contrast of the DBR) and the number of DBR pairs. These modifications affect not only the sharpness of the Tamm plasmon mode but also angle dependence. FIGS. 9A, 9B and 9C show a modulation depth according to the number N of insulating pairs in a DBR structure (N=3 in Embodiment 1), in which FIG. 9A shows electric field distribution, FIG. 9B shows an absorption profile, and FIG. 9C shows an absorption spectrum of a Tamm plasmon structure.

### Experiment Example 4. Structural Analysis of ECTP With an Optical Switching Mechanism

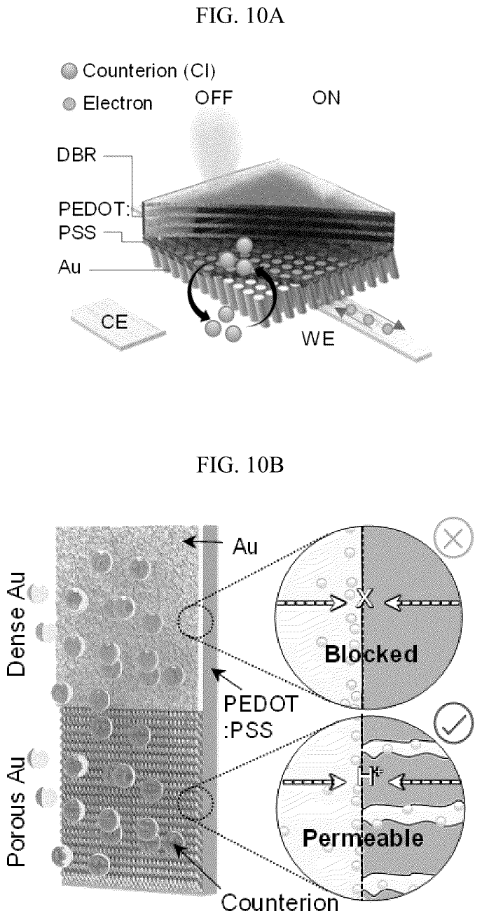

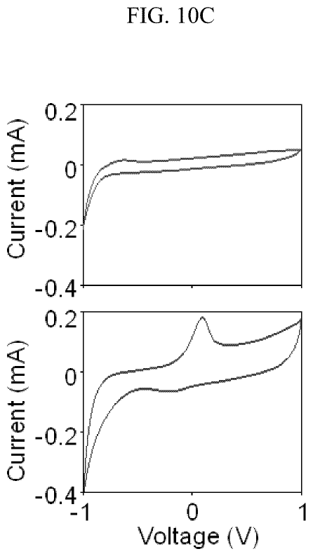

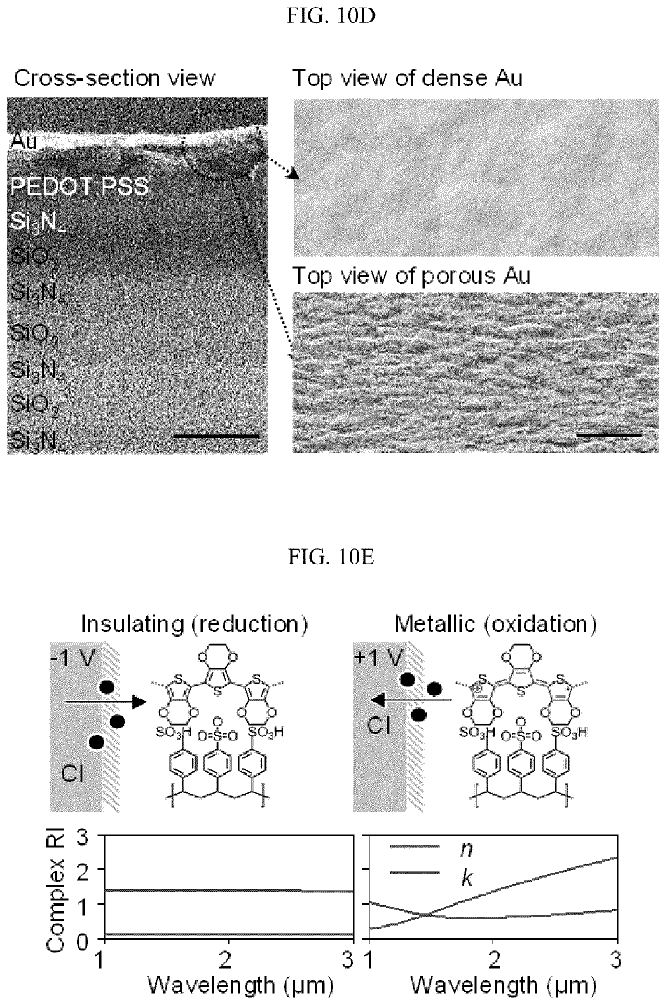

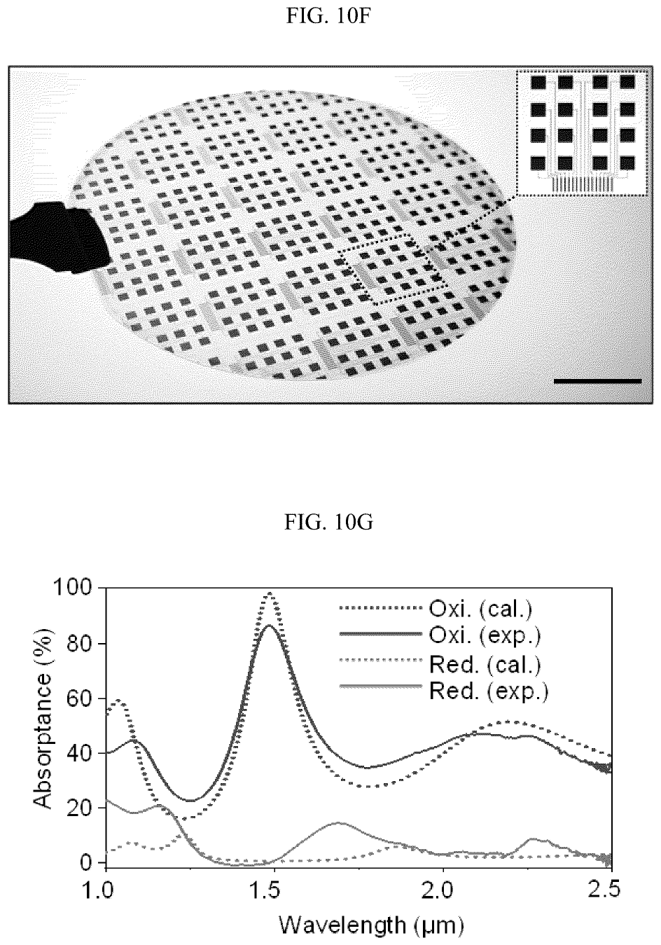

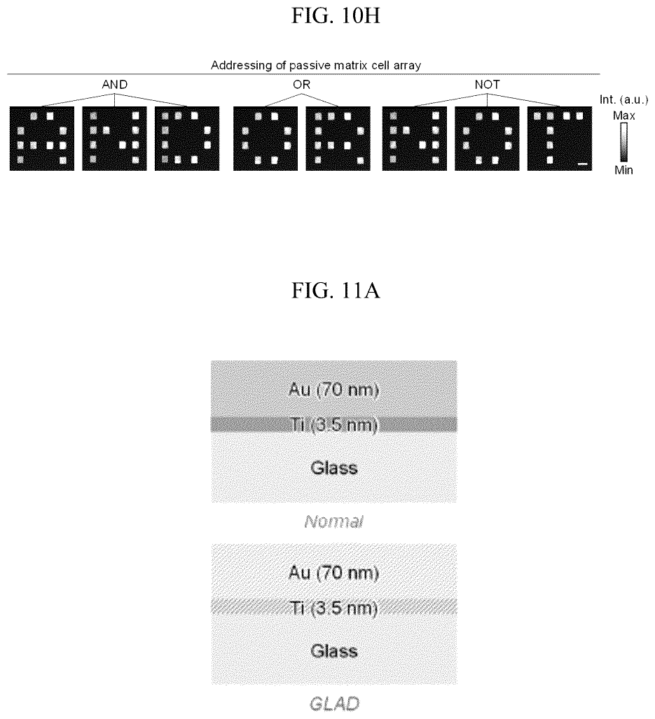

FIG. 10A shows a schematic of a ECTP unit cell with charge carriers. The blue circle and the orange circle represent a counterion and an electron, respectively. The arrows in FIG. 10A indicate the exchange of charge carriers during the doping and dedoping processes. A PEDOT:PSS layer maintains charge balance corresponding to electron transfer associated with positive voltage and negative voltage by absorbing and releasing counterions, respectively.

FIG. 10B shows that a porous Au layer facilitates counterion transport between an electrolyte and a PEDOT:PSS layer, while a dense Au layer blocks counterion exchange. A porous Au layer deposited by glancing angle deposition (GLAD) minimizes degradation of electrical characteristics (3-fold decrease) and has a surface roughness of only 2-4 nm compared to the dense Au layer.

As a proof of concept, a current was measured in response to an applied voltage (vs. Ag/AgCl) for various metal structures (dense Au (Dens Au) and porous Au (Porous Au). FIG. 10C shows cyclic voltammetry plots of the ECTP with (red line) and without (blue line) a porous layer.

The ECTP with the porous Au layer (Embodiment 1) exhibits a peak current 13 times higher than the one without it. This significant increase in the peak current indicates gold ion exchange through Au nanocolumns.

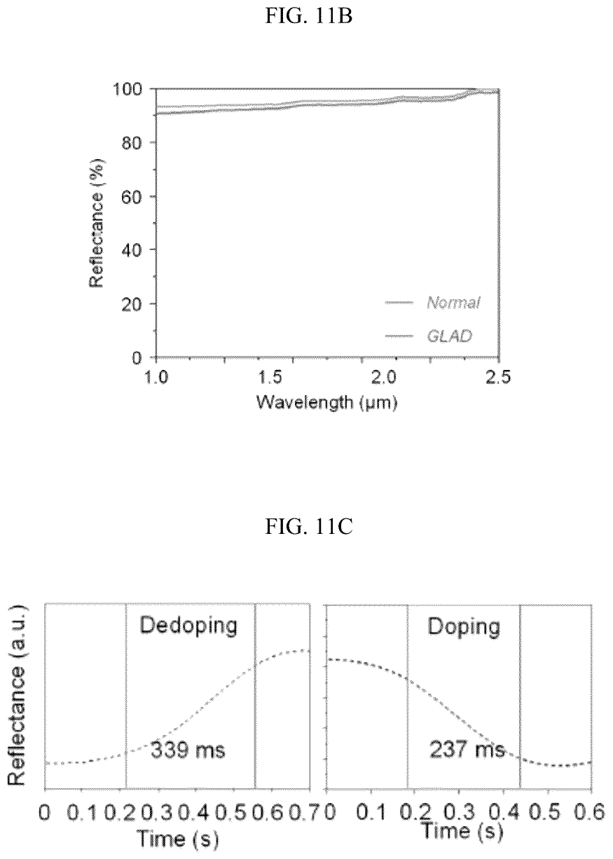

Further, to experimentally verify that a porous Au layer maintains a high level of reflectance comparable to a dense Au layer, dense Au was formed by normal deposition (Normal, top image in FIG. 11A and porous Au was formed by glancing angle deposition (GLAD, bottom image in FIG. 11A on titanium (Ti) layered on a glass substrate, as in FIG. 11A, and then reflectance was measured as shown in FIG. 11B. Referring to FIG. 11B, it can be seen that the porous Au (GLAD) deposited by glancing angle deposition does not degrade the quality of the Tamm state.

Further, an ECTP with porous Au (Embodiment 1) exhibited significantly increased switching times of 339 ms and 237 ms during dedoping and doping processes, respectively, unlike the Tamm plasmon with dense Au (FIG. 11C). However, the switching time of the ECTP appears relatively slow compared to a PEDOT:PSS-based metasurface, mainly due to limited ion exchange.

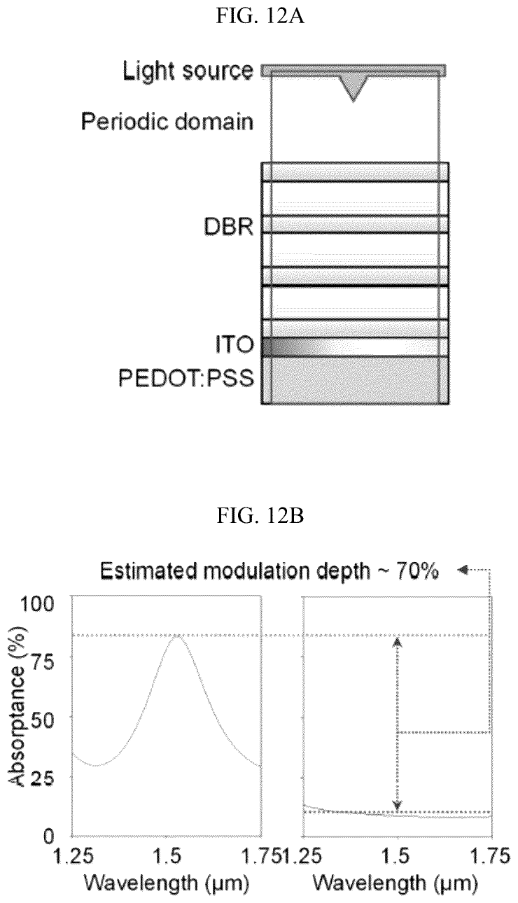

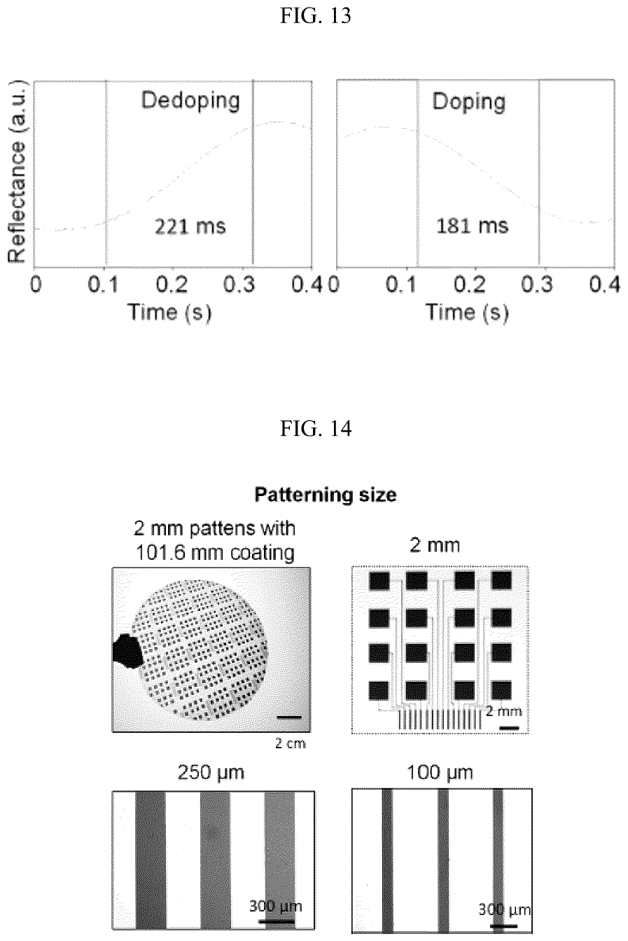

Meanwhile, to improve the modulation speed of the ECTP, a conductive layer with ITO (thickness: 100 nm) was inserted between the PEDOT:PSS and DBR structures by removing the porous Au membrane, as shown in FIG. 12A. Referring to FIG. 12B and FIG. 13, this improves the response times measured at 221 ms and 181 ms while maintaining a modulation depth of 70%.

FIG. 10D is a cross-sectional scanning electron microscope (SEM) image of alternating layers in an ECTP unit cell. The upper SEM image shows a smooth surface for dense Au (top right: Top view of dense Au) and a textured surface for porous Au (bottom right: Top view of porous Au). In the ECTP with porous Au, enhanced permeability of counterions promotes redox processes due to rapid exchange of counterions, thereby enabling complete modulation of the complex refractive index (FIG. 10E). When oxidation occurs, a large k value is observed, and the material exhibits metallic behavior, whereas reduction brings the material close to zero, so it reveals dielectric characteristics. In the metallic state, the k value tends to decrease at shorter wavelengths, which means that it is difficult to achieve a efficient optical modulator in the shorter wavelength range.

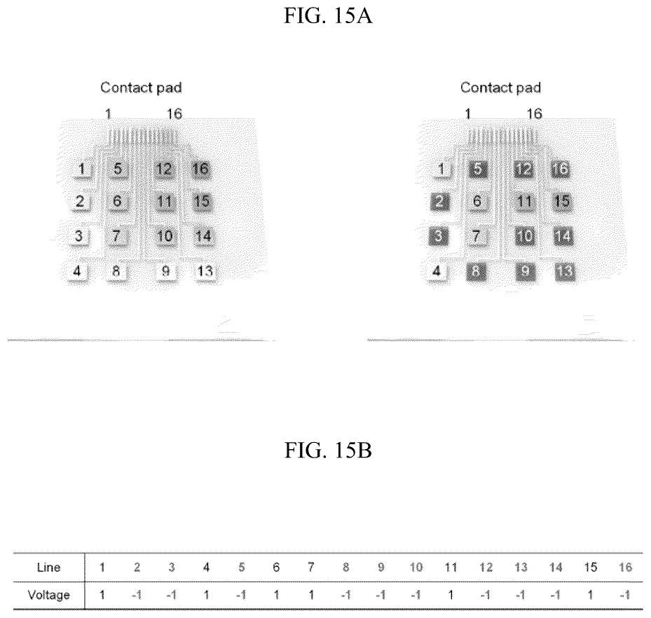

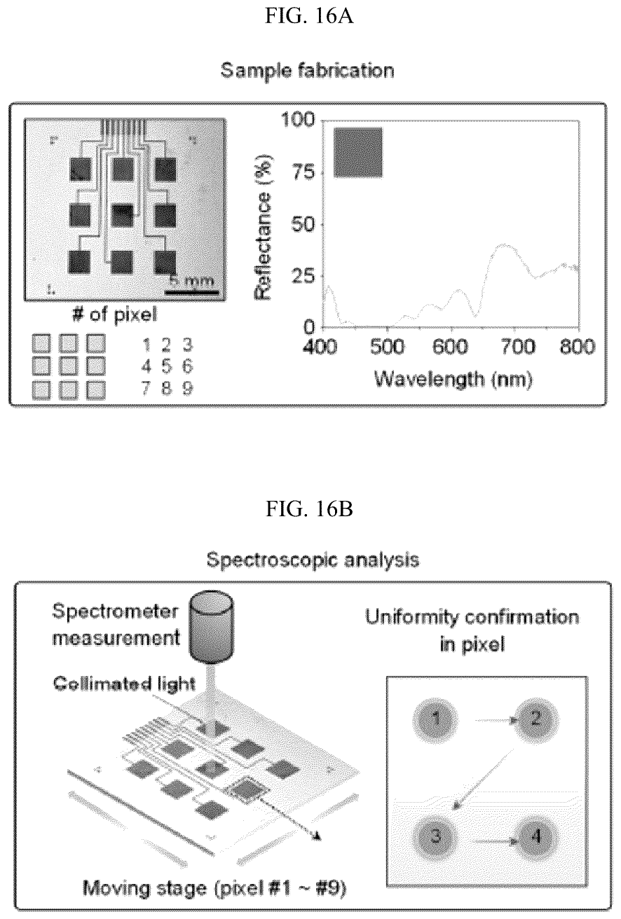

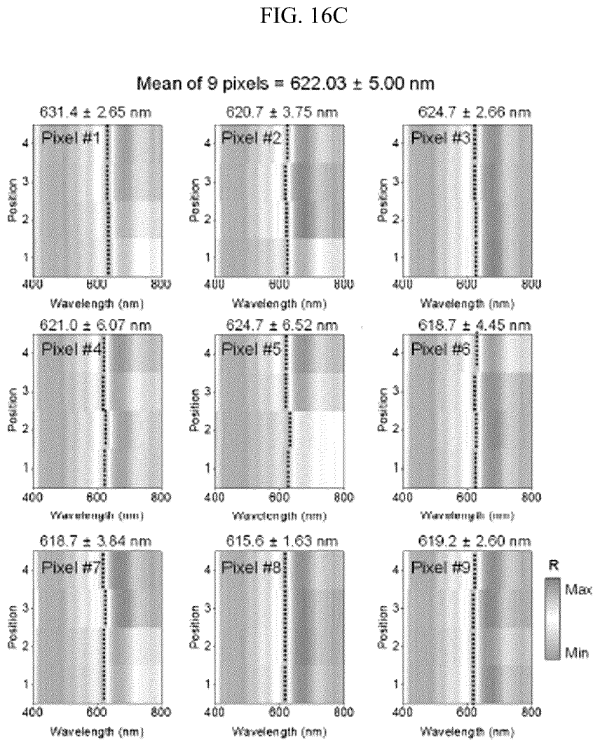

An ECTP array manufactured by the method of Embodiment 1 on a 4-inch wafer scale may be configured with each layer as shown in FIG. 10F. FIG. 14 shows photographic images of an ECTP at different patterning size scales, and PEDOT:PSS provides a flexible and customizable scaling factor. Further, previous studies also strongly supported the feasibility of scaling a structure down to a tens-of-nanometers scale. FIG. 10G shows an experimentally obtained absorption spectrum (solid line) from a single ECTP cell. This result closely matches a numerically predicted curve (dotted line) in terms of line shape and peak value. The ECTP cells are used, as shown in FIG. 10H, to display individually addressable ECTP cells forming the characters “AND,” “OR,” and “NOT.” A description of passive matrix addressing is shown in FIG. 15. FIG. 16 shows verification of inter-pixel and intra-pixel uniformity, in which FIG. 16A shows a photographic image of a fabricated ECTP including nine pixels within a 15 mm×15 mm area and the measured reflectance spectra, FIG. 16B shows a schematic of area measurement of the nine pixels, where a calibrated light source was swept across a stage to measure a reflectance spectrum of each section within a single pixel, FIG. 16C shows reflectance contour maps measured for pixels and sub-locations, respectively, where the average wavelength (622.03 nm) and standard deviation (5 nm) among the nine pixels were calculated on the basis of a resonant wavelength (black dashed line); Referring to FIGS. 16A, 16B and 16C, each pixel exhibits subtle differences between pixels and within individual pixels and consistently shows similar reflected intensity.

### Experimental Example 5. Electrically Triggered Optical Response and Programmable Memory Functions

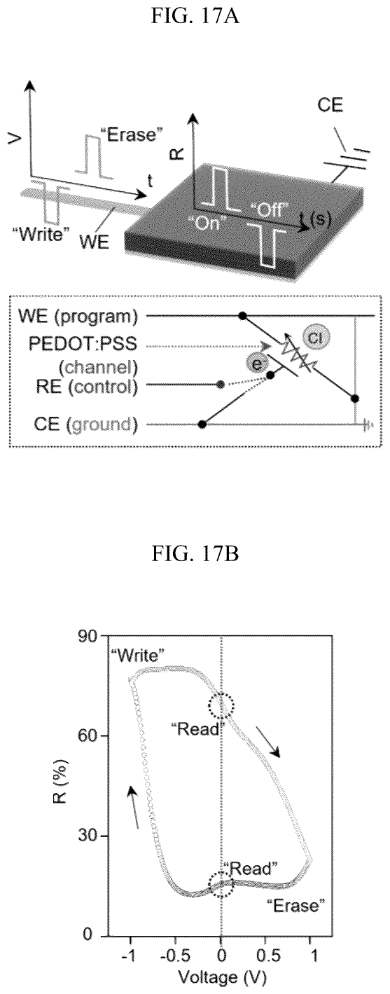

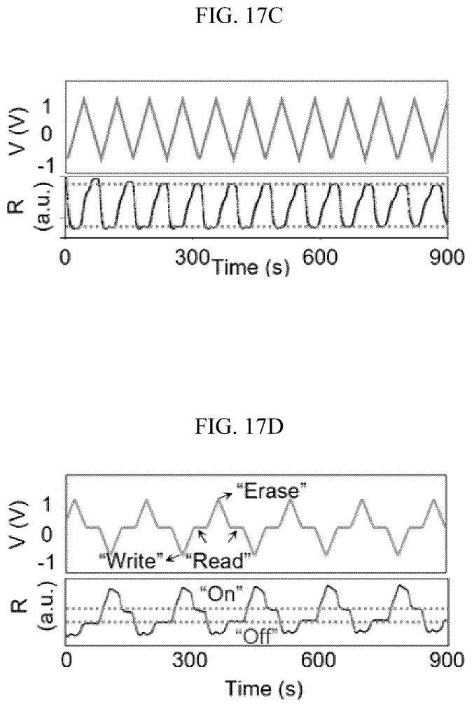

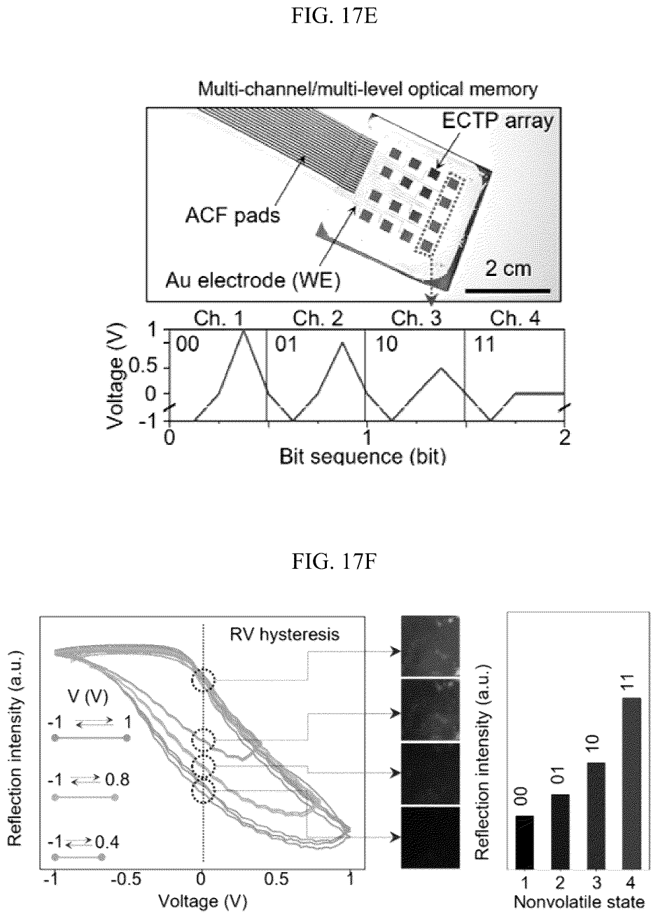

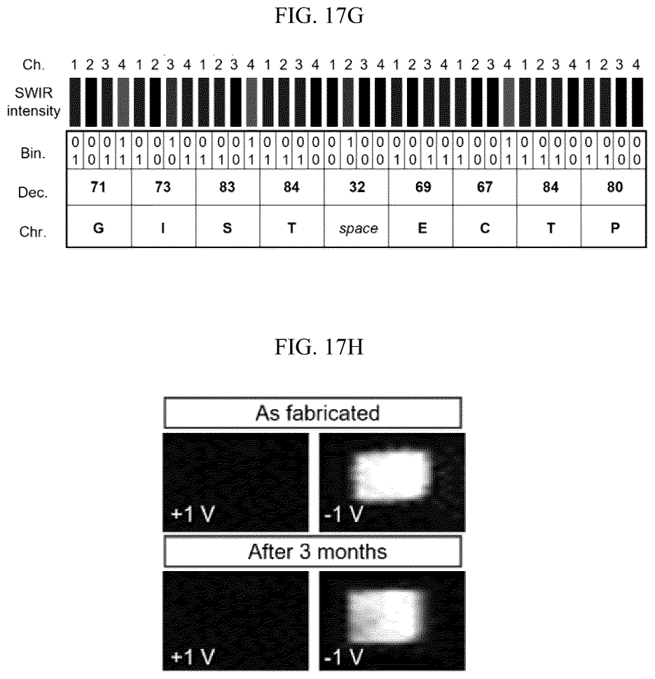

Due to the optical hysteresis characteristic of PEDOT:PSS, the optical modulation device (optical modulator) of the present disclosure has potential for use in optical memory applications. FIG. 17A shows a conceptual diagram of a programmable ECTP defining information state within a cell using electrical pulses having positive potential and negative potential. The inset in FIG. 17A shows circuit modeling of the photonic cell using electrical components (electrodes and related parts). FIG. 17B shows reflectance data points obtained while voltage sweep decreases after voltage sweep increases from −1V to 1V, thereby showing a hysteresis loop, i.e., reflectance-voltage (RV) hysteresis. In particular, two distinguishable reflectance values at 0 V were obtained, which shows a non-volatile and significant intensity difference with approximately 60% switching contrast (FIG. 17B). This unique characteristic can be efficiently used to convert into digital signals, so it has advantages in the fields of data storage and communication. FIG. 17C shows modulation of reflectance using a series of triangular input voltage signals. A pulse of negative (−1V) was used for a “Write” operation, a pulse of positive (1V) was used for an “Erase” operation, and a pause at 0V was used for a “Read” step therebetween. As shown in FIG. 17D, this process clearly demonstrated an electrically programmable and erasable read-only memory effect.

High contrast observed at a “Read” phase value enables implementation of a multi-level memory by utilizing various maximum voltage values. For multi-channel and multi-level demonstration, a 4×4 ECTP cell array was constructed and attached to a control board with anisotropic conductive film (ACF) pads for controlling the potential of each cell (FIG. 17E, top image), where each channel was programmed with a different potential to collectively represent four states corresponding to a 2-bit sequence (FIG. 17E, bottom image). FIG. 17F shows RV hysteresis loops with three different voltage sweep ranges, in which four different readout values are exhibited at 0 V. The operation of a multi-level memory enhances the memory capacity achievable within a single chip. At each reflectance readout at 0 V, a short-wave infrared (SWIR) camera captured images with clearly distinguishable reflected intensities. FIG. 17F also shows acquired reflected intensities, which correspond to a 2-bit states expressed as binary combinations 00, 01, 10, and 11.

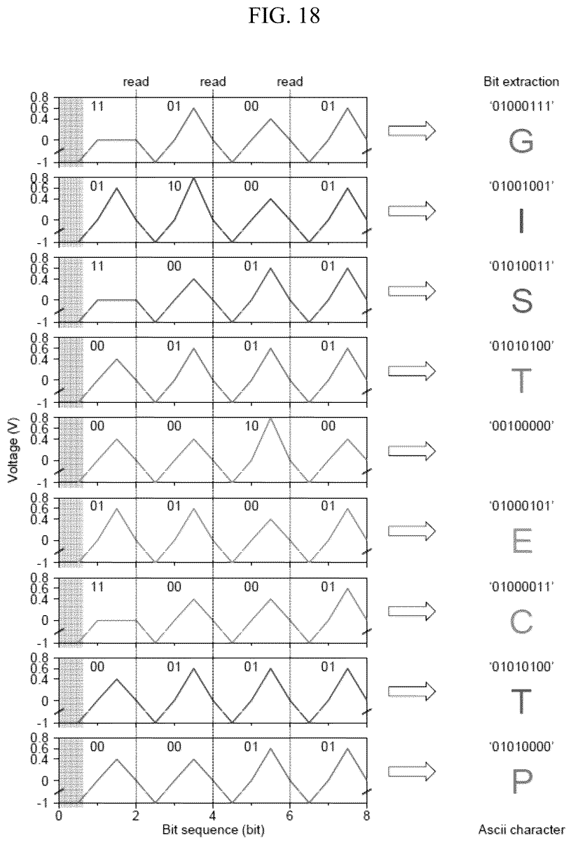

Finally, the ECTP array is used to encode and decode American Standard Code for Information Interchange (ASCII) codes. By applying different voltage sweep ranges, the characters “GIST ECTP” were encoded into ASCII codes and then decoded into the same characters by reading reflectance (FIG. 17G). The specific voltage sweep ranges used in the encoding process are shown in FIG. 18, and as shown in FIG. 17F, the ECTP exhibits four distinguishable states at the readout value (0 V) by applying different voltage sweep ranges. Further, it can be seen that pixels operated stably for over three months (FIG. 17H). However, as seen in the SWIR image of FIG. 17H, slight degradation appears to be present. Possible contributing factors may include volumetric expansion of a polymer during switching and irreversible reactions during electrochemical oxidation and reduction. In this context, the solubility of pure PEDOT:PSS films in aqueous environments is often considered a limitation indicating incompatibility with such conditions. To describe the lifetime of PEDOT:PSS under repeated sweeping, Karst et al. demonstrated degradation of photonic response after 290 cycles of sweeping. Alternatively, material engineering and additives for enhancing the crosslinking of PEDOT:PSS, such as 3-glycidyloxypropyltrimethoxysilane (GOPS), can improve stability in aqueous environments. Nonetheless, a comprehensive review of optical properties is also essential.

### Experimental Example 6. Synaptic Characteristics of ECTP

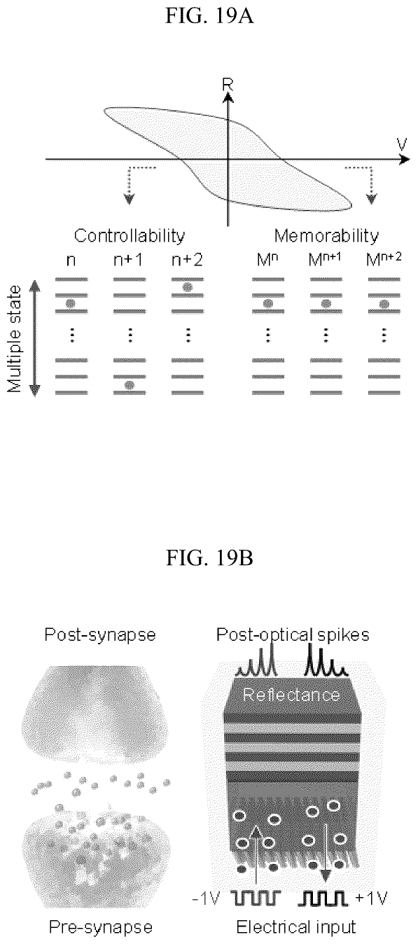

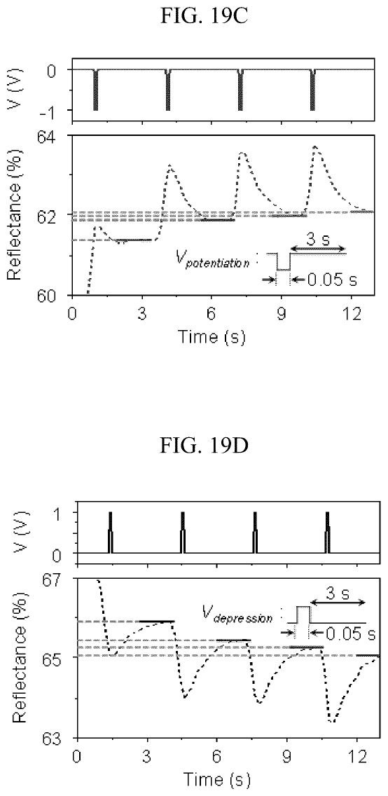

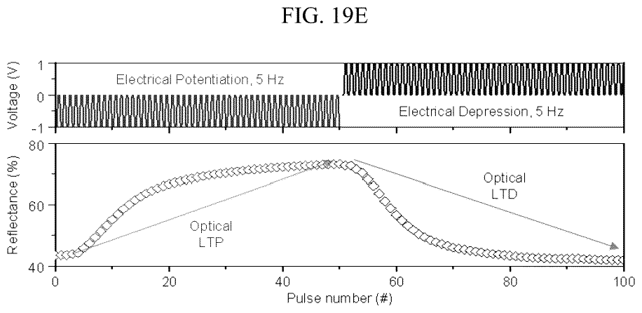

The inherent efficiency and high-speed computing capability of parallel and adaptive learning systems have drawn significant attention by surpassing the traditional von Neumann architecture. Optically nonvolatile memory devices hold the potential to enable the functionality of photonic neuromorphic systems by allowing fine modulation and sustained retention of photonic responses in specific states induced by hysteresis behavior associated with applied potential and pulsed flux. To achieve neuromorphic responses similar to biological systems, two critical aspects of controllability and memory play a role (FIG. 19A). In this context, an ECTP device exhibits a wide range of resistance-voltage (RV) hysteresis, thereby enabling precise control of multiple memory states. Further, its nonvolatile nature ensures effective retention of optical signals. Very similarly to biological synapses and neurons, the optical state of an ECTP is controlled by counterions corresponding to an applied voltage (FIG. 19B, left image). Modulation strength is determined by a previous optical state (FIG. 19B, right image), which is analogous to how the strength of neural pathways (synaptic weights) between adjacent neurons in biological systems is influenced by neurotransmitter release and previous information states and enables phenomena such as long-term potentiation (LTP) and long-term depression (LTD).

To demonstrate electrically controlled synaptic weight variation (i.e., reflectance variation) of an ECTP, the relationship between synaptic behavior and the number of electrical pulses was investigated. Electrical inputs with a pulse width of 50 ms were applied to achieve four stable synaptic weights. Initially, relative reflectance started below 60%. Subsequently, pulses with a voltage of −1 V (50 ms) were applied to generate four different reflectance states having potentiation characteristics, as shown in FIG. 19C. To achieve suppression of an optical signal, pulses with a voltage of +1 V (50 ms) were applied, so intensity gradually decreased (FIG. 19D). The measurement results exhibited that the optical state of the ECTP was effectively controlled under pulses of 1 V and exhibited multiple reflectance states. FIG. 19E shows optical long-term potentiation (LTP) and long-term depression (LTD) behaviors observed during the application of 100 pulses at −1 V and +1 V with a frequency of 5 Hz. Under electrically potentiating pulses (−1 V), the reflectance of the ECTP increased from 43% to 73%. In contrast, under electrically depressing pulses (+1 V), the reflectance decreased from the maximum to 42%. Variation in reflectance of the ECTP corresponds to pulses applied for potentiation or depression and is distinguishable. The reflectance variation approaches saturation at 50 pulses and continue to show significant and persistent reflectance variation even after long-term measurements including more than 100 pulses. Accordingly, the type and number of applied electrical pulses determine a broad range of optical state of the ECTP. This characteristic of the PEDOT:PSS-based photonic structure holds significant potential to advance the development of optical neuromorphic systems in near-infrared (NIR) photonic computing/communication applications.

Although embodiments of the present disclosure were described above in detail, the spirit of the present disclosure is not limited thereto and the present disclosure may be changed and modified in various ways on the basis of the basic concept without departing from the scope of the present disclosure described in the following claims.

### IDENTIFICATION

100: optical modulation device

What is claimed is:

1. An optical modulation device comprising:
a photonic crystal structure in which different insulators are stacked; and
an optical property modulation active layer formed on one surface of the photonic crystal structure.

2. The optical modulation device of claim 1, wherein the photonic crystal structure is a Tamm plasmon structure.

3. The optical modulation device of claim 1, wherein the photonic crystal structure includes a distributed Bragg reflector (DBR) structure.

4. The optical modulation device of claim 3, wherein the DBR structure includes a DBR unit layer configured by stacking a first insulator layer and a second insulator layer.

5. The optical modulation device of claim 4, wherein the first insulator layer is Si₃N₄.

6. The optical modulation device of claim 5, wherein the second insulator layer is SIO₂.

7. The optical modulation device of claim 4, wherein the DBR structure has one to four DBR unit layers.

8. The optical modulation device of claim 3, wherein the photonic crystal structure includes a third insulator layer disposed for one surface of the DBR structure.

9. The optical modulation device of claim 8, wherein the third insulator layer is Si₃N₄.

10. The optical modulation device of claim 1, wherein the optical property modulation active layer is PEDOT:PSS.

11. The optical modulation device of claim 1, further comprising a porous reflective layer formed on one surface of the optical property modulation active layer.

12. The optical modulation device of claim 11, wherein the porous reflective layer is gold (Au).
